(19) United States
(12) Patent Application Publication
(10) Pub. No.: US 2026/0009435 A1
(43) Pub. Date: Jan. 8, 2026

(54) BRAKE DRIVING DEVICE FOR DRIVING MECHANICAL BRAKE DEVICE

(71) Applicant: FANUC CORPORATION, Minamitsuru-gun, Yamanashi (JP)

(72) Inventor: Keitarou INAGAKI, Minamitsuru-gun, Yamanashi (JP)

(73) Assignee: FANUC CORPORATION, Minamitsuru-gun, Yamanashi (JP)

(21) Appl. No.: 18/994,193

(22) PCT Filed: Nov. 4, 2022
(86) PCT No.: PCT/JP2022/041209

§ 371 Date: Jan. 14, 2025

(51) Int. Cl. F16D 59/02; F16D 121/14; F16D 121/22

(52) U.S. Cl. CPC F16D 59/02; F16D 2121/14; F16D 2121/22

(57) ABSTRACT

This brake driving device comprises: a positive-side switch for opening/closing a positive-side electrical path between a power source and a mechanical brake device; a negative-side switch for opening/closing a negative-side electrical path between the power source and the mechanical brake device; and a switch control unit for outputting an OFF signal to the positive-side switch and the negative-side switch when braking is to be activated, outputting an ON signal to the positive-side switch and the negative-side switch at the start of brake release when braking is to be released, and while subsequently keeping the braking released, alternately switching between output of a PWM-controlled ON/OFF signal to the positive-side switch and output of the PWM-controlled ON/OFF signal to the negative-side switch at predetermined time intervals.

### TECHNICAL FIELD

The present disclosure relates to a brake driving device that drives a mechanical brake device.

### BACKGROUND ART

In a motor driving device that drives a motor in a machine such as an industrial robot and a machine tool, a mechanical brake device of a non-excitation actuating type is widely used for applying a brake to the rotating motor, and fixing the stopped motor in such a way as to prevent the motor from rotating. A switch is connected between a brake coil of the mechanical brake device and a power supply. A current flows from the power supply to the brake coil by the switch performing an ON motion, and the brake by the mechanical brake device is released. Further, a current is prevented from flowing from the power supply to the brake coil by the switch performing an OFF motion, and thus the brake of the mechanical brake device is actuated.

### CITATION LIST

### Patent Literature

[PTL 1] JP 2019-119530A
[PTL 2] JP 2011-195287A
[PTL 3] JP 2007-143311A
[PTL 4] JP H08-182365A

### SUMMARY OF INVENTION

### Technical Problem

A brake driving device that can easily make a diagnosis of a fault in a switch provided between a brake coil of a mechanical brake device and a power supply and can also reduce size and heat generation of the mechanical brake device is desired.

### Solution to Problem

According to one aspect of the present disclosure, a brake driving device includes: a positive switch configured to close a positive electric circuit between a positive terminal of a power supply and a positive terminal of a mechanical brake device of a non-excitation actuating type by performing an ON motion, and open the positive electric circuit by performing an OFF motion; a negative switch configured to close a negative electric circuit between a negative terminal of the power supply and a negative terminal of the mechanical brake device by performing the ON motion, and open the negative electric circuit by performing the OFF motion;

and a switch control unit configured to output, to the positive switch and the negative switch, an ON signal for causing the ON motion to be performed and an OFF signal for causing the OFF motion to be performed, wherein the switch control unit outputs, when a brake by the mechanical brake device is actuated, the OFF signal to the positive switch and the negative switch, and outputs, when the brake by the mechanical brake device is released, the ON signal to the positive switch and the negative switch at a time of brake release start, and then alternately switches between and performs, for each predetermined period of time, an output of the ON signal and the OFF signal subjected to PWM control for the positive switch and an output of the ON signal and the OFF signal subjected to PWM control for the negative switch while release of the brake by the mechanical brake device is maintained.

### BRIEF DESCRIPTION OF DRAWINGS

FIG. 1 is a circuit diagram illustrating a brake driving device according to a first embodiment of the present disclosure.

FIG. 2 is a cross-sectional view illustrating a structure of a mechanical brake device controlled by the brake driving device according to the first embodiment and a second embodiment of the present disclosure, and illustrates a state where a brake is actuated for a motor.

FIG. 3 is a cross-sectional view illustrating a structure of the mechanical brake device controlled by the brake driving device according to the first and second embodiments of the present disclosure, and illustrates a state where the brake for the motor is released.

FIG. 4 is a timing chart illustrating actuation and release of a brake of the mechanical brake device in the brake driving device according to the first and second embodiments of the present disclosure.

FIG. 5 is a timing chart illustrating each waveform when a positive switch and a negative switch of the brake driving device according to the first and second embodiments of the present disclosure are normal.

FIG. 6 is a timing chart illustrating each waveform when the positive switch of the brake driving device according to the first and second embodiments of the present disclosure experiences a short circuit failure.

FIG. 7 is a timing chart illustrating each waveform when the positive switch of the brake driving device according to the first and second embodiments of the present disclosure experiences an open circuit failure.

FIG. 8 is a flowchart illustrating a motion related to a fault diagnosis in the brake driving device according to the first embodiment of the present disclosure.

FIG. 9 is a circuit diagram illustrating the brake driving device according to the second embodiment of the present disclosure.

FIG. 10 is a flowchart illustrating a motion related to a fault diagnosis in the brake driving device according to the second embodiment of the present disclosure.

### DESCRIPTION OF EMBODIMENTS

Hereinafter, a brake driving device that drives a mechanical brake device according to embodiments will be described with reference to drawings. It should be noted that a configuration having the same or similar function is provided with the same reference sign in the following description. Then, redundant description of the configuration may be omitted. Herein, “ON” of a switch means closing of an electric circuit provided with the switch, that is, when a switch performs an ON motion, an electric circuit provided with the switch is connected and brought into a closed state. Further, “OFF” of a switch means opening of an electric circuit provided with the switch, that is, when a switch performs an OFF motion, an electric circuit provided with the switch is disconnected and brought into an open state.

### Configuration of Brake Driving Device According to First Embodiment

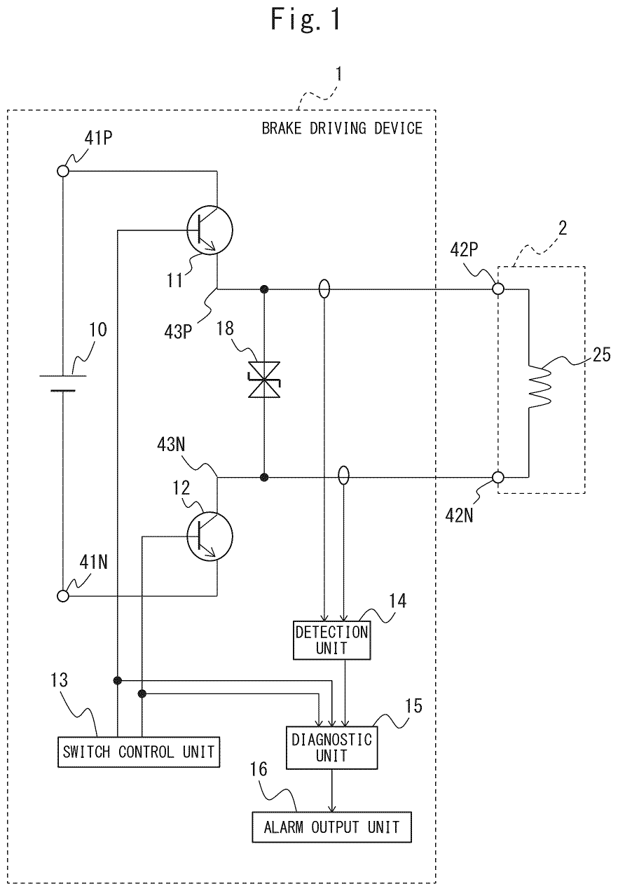

FIG. 1 is a circuit diagram illustrating a brake driving device according to a first embodiment of the present disclosure.

A mechanical brake device 2 controlled by a brake driving device 1 according to the first embodiment of the present disclosure is a brake device of a non-excitation actuating type that actuates a brake during non-excitation without application of a voltage to a brake coil 25, and releases the brake during excitation with application of a voltage to the brake coil 25.

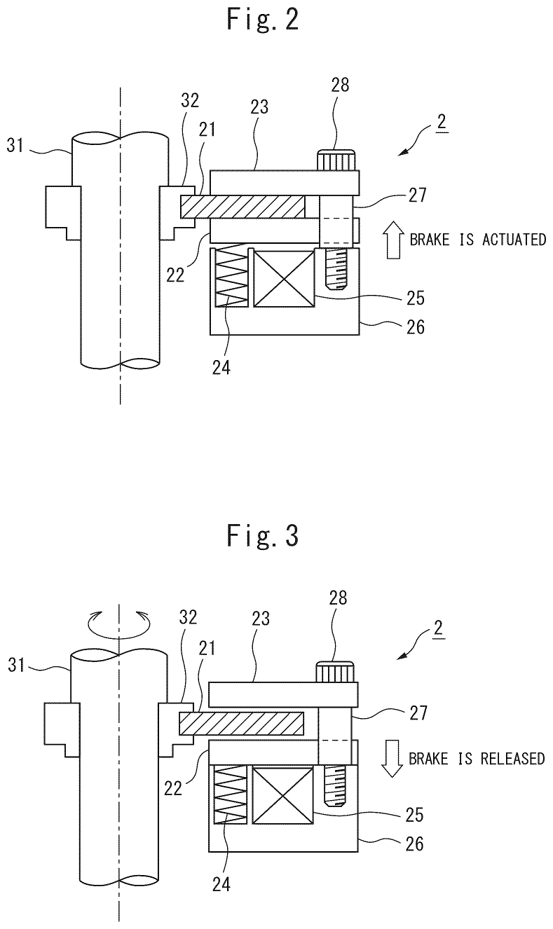

Prior to description of the brake driving device 1 according to the first embodiment of the present disclosure, a structure of the mechanical brake device 2 controlled by the brake driving device I will be described with reference to FIGS. 2 and 3. FIG. 2 is a cross-sectional view illustrating a structure of the mechanical brake device controlled by the brake driving device according to the first embodiment and a second embodiment of the present disclosure, and illustrates a state where a brake is actuated for a motor. FIG. 3 is a cross-sectional view illustrating a structure of the mechanical brake device controlled by the brake driving device according to the first and second embodiments of the present disclosure, and illustrates a state where the brake for the motor is released. The mechanical brake device 2 illustrated in FIGS. 2 and 3 is applicable to the first and second embodiments.

As illustrated in FIGS. 2 and 3, in the mechanical brake device 2, a friction plate 21 is disposed between an armature 22 and an end plate 23. A hub 32 is spline-coupled to the friction plate 21. The hub 32 and a shaft 31 of a motor are integrated by, for example, shrink fitting, and thus the friction plate 21 also rotates in conjunction with rotation of the shaft 31 of the motor. The end plate 23 and a spacer 27 are coupled by a bolt 28, and the armature 22 is coupled to the spacer 27 in such a way that the armature 22 can move in a direction closer to and a direction away from the friction plate 21. A spring 24 and the brake coil 25 are provided in a core 26. As illustrated in FIG. 2, in a non-excitation state where no voltage is applied to the brake coil 25, the armature 22 is strongly pressed against the friction plate 21 by an elastic force of the spring 24, and the friction plate 21 is sandwiched between the armature 22 and the end plate 23 and cannot rotate. As a result, the shaft 31 of the motor coupled to the friction plate 21 cannot also rotate, which results in a state where the brake is actuated for the motor (brake actuating state). On the other hand, as illustrated in FIG. 3, in an excitation state where a brake current flows through the brake coil 25, an electromagnetic force that defeats the elastic force of the spring 24 pressing the armature 22 against the friction plate 21 is generated in the core 26, and the armature 22 is thus brought closer to the core 26, and the friction plate 21 is released from contact with the armature 22 and the end plate 23. As a result, the friction plate 21 and thus the shaft 31 of the motor can freely rotate, which results in a state where the brake for the motor is released (brake releasing state).

The mechanical brake device 2 is controlled by the brake driving device 1. As illustrated in FIG. 1, the brake driving device I according to the first embodiment of the present disclosure includes a power supply 10, a positive switch 11, a negative switch 12, a switch control unit 13, a detection unit 14, a diagnostic unit 15, an alarm output unit 16, and a surge absorber 18. FIG. 1 illustrates only the brake coil 25 for the mechanical brake device 2.

The power supply 10 outputs a direct-current voltage. The power supply 10 is formed of, for example, a rectifier that converts an alternating-current voltage into a direct-current voltage, a switching regulator, a battery, or the like. As one example, the power supply 10 outputs a direct-current voltage having a voltage value of 24 V, but may be a power supply that outputs a direct-current voltage having another voltage value (for example, 15 V, 12 V, 5 V, and the like).

The positive switch 11 and the negative switch 12 are each connected in series with the brake coil 25 of the mechanical brake device 2. In the example illustrated in FIG. 1, the positive switch 11 that opens (disconnects) or closes (connects) a positive electric circuit 43P between a positive terminal 41P of the power supply 10 and a positive terminal 42P of the mechanical brake device 2 is provided. Further, the negative switch 12 that opens (disconnects) or closes (connects) a negative electric circuit 43N between a negative terminal 41N of the power supply 10 and a negative terminal 42N of the mechanical brake device 2 is provided. It should be noted that, in the example illustrated in FIG. 1, one positive switch 11 and one negative switch 12 are provided, but two or more positive switches 11 and two or more negative switches 12 may be provided as a modification example. As an example of the positive switch 11 and the negative switch 12, there are an FET, an IGBT, a thyristor, a GTO, a transistor, a relay, and the like. A kind itself of the positive switch 11 and the negative switch 12 does not limit the present embodiment, and a switching element other than the exemplified switch may be used.

The ON motion and the OFF motion of the positive switch 11 and the negative switch 12 are controlled by the switch control unit 13.

In other words, the switch control unit 13 transmits an ON signal to the positive switch 11 and the negative switch 12 in order to perform control for causing the positive switch 11 and the negative switch 12 to perform the ON motion. When the positive switch 11 receives the ON signal from the switch control unit 13, the positive switch 11 performs the ON motion and closes the positive electric circuit 43P between the power supply 10 and the brake coil 25. When the negative switch 12 receives the ON signal from the switch control unit 13, the negative switch 12 performs the ON motion and closes the negative electric circuit 43N between the power supply 10 and the brake coil 25. However, in a case where the positive switch 11 or the negative switch 12 experiences an open circuit failure, the switch does not perform the ON motion even when the switch receives the ON signal from the switch control unit 13.

Further, the switch control unit 13 transmits an OFF signal to the positive switch 11 and the negative switch 12 in order to perform control for causing the positive switch 11 and the negative switch 12 to perform the OFF motion. When the positive switch 11 receives the OFF signal from the switch control unit 13, the positive switch 11 performs the OFF motion and opens the positive electric circuit 43P between the power supply 10 and the brake coil 25. When the negative switch 12 receives the OFF signal from the switch control unit 13, the negative switch 12 performs the OFF motion and opens the negative electric circuit 43N between the power supply 10 and the brake coil 25. However, in a case where the positive switch 11 or the negative switch 12 experiences a short circuit failure, the switch does not perform the OFF motion even when the switch receives the OFF signal from the switch control unit 13.

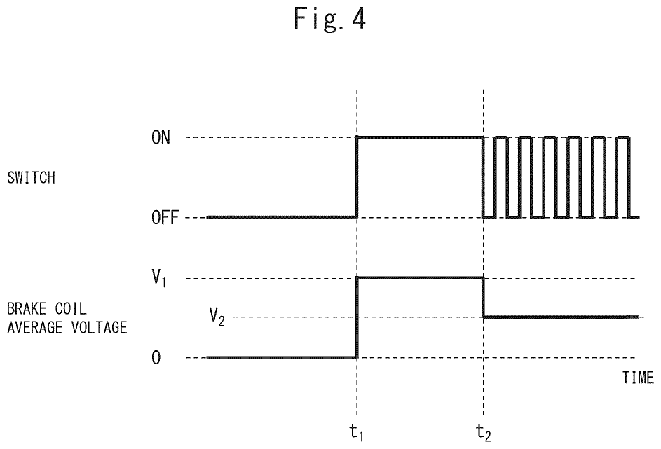

Herein, actuation and release of the mechanical brake device 2 will be described with reference to FIG. 4. FIG. 4 is a timing chart illustrating actuation and release of the brake of the mechanical brake device in the brake driving device according to the first and second embodiments of the present disclosure. The description related to the timing chart illustrated in FIG. 4 is applicable to the first and second embodiments. An upper row in FIG. 4 illustrates a state of ON and OFF of the positive switch 11 or the negative switch 12, and a lower row in FIG. 4 illustrates an average voltage applied to the brake coil 25.

When the brake by the mechanical brake device 2 is actuated (for example, since start to a time t₁), the switch control unit 13 outputs the OFF signal to the positive switch 11 and the negative switch 12. The positive switch 11 and the negative switch 12 that have received the OFF signal from the switch control unit 13 perform the OFF motion and open the positive electric circuit 43P and the negative electric circuit 43N between the power supply 10 and the brake coil 25. In this way, a current from the power supply 10 to the brake coil 25 is cut off, and thus an average voltage of the brake coil 25 is 0 (zero), and there is no electromagnetic force generated in the core 26. An elastic force of the spring 24 defeats an electromagnetic force generated in the core 26, and thus the armature 22 is strongly pressed against the friction plate 21, and the brake by the mechanical brake device 2 is actuated (brake actuating state).

When the brake by the mechanical brake device 2 is released, the switch control unit 13 performs a series of the following pieces of control. First, the switch control unit 13 outputs the ON signal to the positive switch 11 and the negative switch 12 at the time t1 being a time of brake release start. The positive switch 11 and the negative switch 12 that have received the ON signal from the switch control unit 13 close the positive electric circuit 43P and the negative electric circuit 43N. In this way, a current flows from the power supply 10 to the brake coil 25, an average voltage of the brake coil 25 is V₁, and an electromagnetic force that defeats an elastic force of the spring 24 for pressing the armature 22 against the friction plate 21 is generated in the core 26. The armature 22 is brought closer to the core 26 by the electromagnetic force, and the friction plate 21 is released from contact with the armature 22 and the end plate 23. As a result, the friction plate 21 and thus the shaft 31 of the motor can freely rotate, which results in a state where the brake for the motor is released (brake releasing state).

After the brake of the mechanical brake device 2 is released once, even an electromagnetic force smaller to some extent than an electromagnetic force generated in the core 26 at the time of brake release start can defeat an elastic force of the spring 24. Thus, at a time t₂, in order to maintain the brake releasing state, the switch control unit 13 alternately switches between and performs, for each predetermined period of time, an output of the ON signal and the OFF signal subjected to pulse width modulation (PWM) control for the positive switch 11 and an output of the ON signal and the OFF signal subjected to PWM control for the negative switch 12. In the upper row in FIG. 4, the state of ON and OFF of one switch of the positive switch 11 and the negative switch 12 is illustrated as one example. The switch control unit 13 outputs the ON signal to the negative switch 12 while the switch control unit 13 outputs the ON signal and the OFF signal subjected to PWM control for the positive switch 11. Further, the switch control unit 13 outputs the ON signal to the positive switch 11 while the switch control unit 13 outputs the ON signal and the OFF signal subjected to PWM control for the negative switch 12. In such a manner, at and after the time t₂ at which the ON and OFF motions of the positive switch 11 and the negative switch 12 are subjected to PWM control, a current also flows from the power supply 10 to the brake coil 25, but magnitude of the current is smaller than magnitude of the current from the time t₁ to the time t₂, and thus an average voltage of the brake coil 25 is V₂ (<V₁), and heat generation of the mechanical brake device 2 is reduced. Further, no problem arises even when the mechanical brake device 2 is reduced in size. A duty ratio used in PWM control is set in advance to magnitude to an extent that an electromagnetic force defeating an elastic force of the spring 24 is generated. By setting the duty ratio in such a manner, the state where the friction plate 21 is released from contact with the armature 22 and the end plate 23 can be maintained, and thus the brake releasing state can be maintained. As an example of the duty ratio used in PWM control, for example, 50% may be set, but a numerical value herein is merely one example, and the other numerical value may be set.

Details will be described below, and a fault diagnosis of the positive switch 11 and the negative switch 12 is made by the diagnostic unit 15 while the switch control unit 13 switches between PWM control for the positive switch 11 and PWM control for the negative switch 12. Thus, in order to achieve a safe brake control (SBC) function conforming to IEC/EN61800-5-2, switching by the switch control unit 13 between an output of the ON signal and the OFF signal subjected to PWM control for the positive switch 11 and an output of the ON signal and the OFF signal subjected to PWM control for the negative switch 12 may be performed for each about 500 milliseconds, for example. The numerical value herein is merely one example, and the other numerical value may be set.

Description returns to FIG. 1, and the surge absorber 18 is connected between the positive terminal and the negative terminal of the brake coil 25 in such a way as to be connected in parallel with the mechanical brake device 2. The surge absorber 18 removes a momentary high voltage such as an opening/closing surge and noise of the switches 11 and 12.

The detection unit 14 detects electricity information being at least one of a voltage applied to the brake coil 25 of the mechanical brake device 2 and a current flowing through the brake coil 25. The electricity information detected by the detection unit 14 is transmitted to the diagnostic unit 15. It should be noted that, hereinafter, a voltage applied to the brake coil 25 may be referred to as a “brake coil voltage”, and a current flowing through the brake coil 25 may be referred to as a “brake coil current”.

The diagnostic unit 15 makes a diagnosis of presence or absence of a fault in the positive switch 11 and the negative switch 12, based on the electricity information detected by the detection unit 14, while the switch control unit 13 alternately switches between and performs, for each predetermined period of time, an output of the ON signal and the OFF signal subjected to PWM control for the positive switch 11 and an output of the ON signal and the OFF signal subjected to PWM control for the negative switch 12.

The alarm output unit 16 outputs an alarm when the diagnostic unit 15 determines that at least one of the positive switch 11 and the negative switch 12 is faulty.

A diagnostic result by the diagnostic unit 15 may be displayed on, for example, a display device (not illustrated), based on an output of an alarm from the alarm output unit 16. As an example of the display device, there are a single display device, a display device attached to the brake driving device 1 or a motor driving device including the brake driving device 1, a display device attached to a personal computer and a portable terminal, and the like. For example, the display device performs display of, for example, “positive switch is normal”, “negative switch is normal”, “positive switch is faulty”, or “negative switch is faulty”. The above-described display example by the display device is merely one example, and “positive switch is normal”, “negative switch is normal”, “positive switch is faulty”, or “negative switch is faulty” may be displayed based on the other expression and illustration. It should be noted that, when the positive switch or the negative switch is faulty, whether the switch experiences a short circuit failure or experiences an open circuit failure may be displayed as a more detailed fault content.

A diagnostic result by the diagnostic unit 15 may be output from an acoustic device (not illustrated) that outputs a sound such as, for example, a voice, a speaker, a buzzer, and a chime, based on an output of an alarm from the alarm output unit 16. For example, in order to be able to distinguish a difference among “positive switch is normal”, “negative switch is normal”, “positive switch is faulty”, and “negative switch is faulty”, a tone color, a musical scale, a rhythm, a melody, or the like may be set. Further, the acoustic device may be silent when “positive switch and negative switch is normal”, and may output a sound only when “positive switch is faulty” or “negative switch is faulty”. It should be noted that, when the positive switch or the negative switch is faulty, the acoustic device may output a sound that can identify whether the switch experiences a short circuit failure or experiences an open circuit failure.

A diagnostic result by the diagnostic unit 15 may be printed out on paper and the like by using a printer and be displayed.

The examples of notification about a diagnostic result by the diagnostic unit 15 to an operator are described above, and may be combined as appropriate and achieved. Further, every time a diagnostic result by the diagnostic unit 15 is acquired, the diagnostic result may be stored, accumulated, databased, and thus used to aid in fault prediction and preventive maintenance.

An operator can quickly and reliably recognize a state of the positive switch 11 and the negative switch 12 of the brake driving device 1, based on a notified diagnostic result by the diagnostic unit 15. Thus, when the operator can confirm that the positive switch 11 or the negative switch 12 is faulty from the diagnostic result by the diagnostic unit 15, for example, the operator can take action such as exchange or repair of the positive switch 11 or the negative switch 12.

At least one processor being an arithmetic processing device is provided in the brake driving device 1 or the motor driving device including the brake driving device 1. As the arithmetic processing device, for example, there are an IC, an LSI, a CPU, an MPU, a DSP, and the like. The arithmetic processing device includes the switch control unit 13, the detection unit 14, the diagnostic unit 15, the alarm output unit 16, and the other processing circuit. Each of these units included in the arithmetic processing device is, for example, a functional module achieved by a program executed on a processor. For example, when the switch control unit 13, the detection unit 14, the diagnostic unit 15, the alarm output unit 16, and the other processing circuit are constituted in a program form, the arithmetic processing device performs a motion according to the program, and thus a function of each unit can be achieved. The program for executing each piece of processing of the switch control unit 13, the detection unit 14, the diagnostic unit 15, the alarm output unit 16, and the other processing circuit may be provided in form of being recorded in a computer-readable recording medium, such as a semiconductor memory, a magnetic recording medium, or an optical recording medium. Alternatively, the switch control unit 13, the detection unit 14, the diagnostic unit 15, the alarm output unit 16, and the other processing circuit may be achieved as a semiconductor integrated circuit to which the program that achieves the function of each unit is written.

At least one memory being a storage device is provided in the brake driving device 1 or the motor driving device including the brake driving device 1. As the memory, there are a non-volatile memory being electrically erasable and recordable such as, for example, an EEPROM (registered trademark), a random access memory that can perform reading and writing at a high speed such as, for example, a DRAM and an SRAM, or the like. Further, the storage device may have a configuration such as, for example, an HDD and an SSD. The program for causing the switch control unit 13, the detection unit 14, the diagnostic unit 15, the alarm output unit 16, and the other processing circuit to perform a motion may be stored in the memory. Electricity information acquired by the detection unit 14 is stored in the memory. A diagnostic result by the diagnostic unit 15 is stored in the memory. Various data related to the brake driving device 1 or the motor driving device including the brake driving device 1 are stored in the memory.

### Motion of Brake Driving Device According to First Embodiment

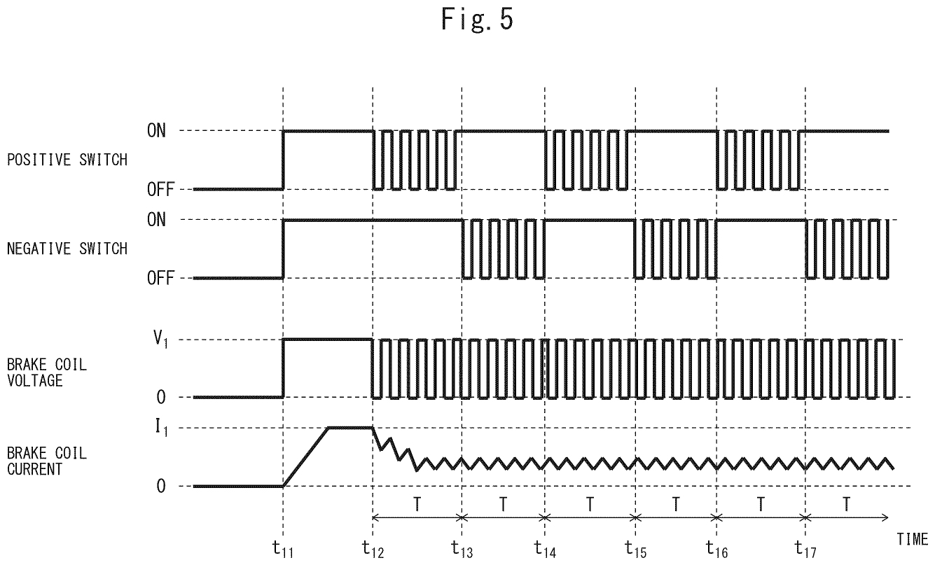

A motion of the brake driving device according to the first embodiment will be described with reference to timing charts illustrated in FIGS. 5 to 7. The description related to the timing charts illustrated in FIGS. 5 to 7 is applicable to the first and second embodiments. FIGS. 5 to 7 illustrate, in order from an upper row to a lower row, an ON signal and an OFF signal applied to the positive switch 11, an ON signal and an OFF signal applied to the negative switch 12, a voltage of the brake coil 25 of the mechanical brake device 2, and a current flowing through the brake coil 25 of the mechanical brake device 2. Further, in FIGS. 5 to 7, it is assumed as one example that brake actuating processing is executed since start to a time t₁₁, brake releasing processing starts at the time t₁₁, and the brake releasing state is maintained at and after the time t₁₁.

FIG. 5 is the timing chart illustrating each waveform when the positive switch and the negative switch of the brake driving device according to the first and second embodiments of the present disclosure are normal.

When the positive switch 11 and the negative switch 12 are normal, the positive switch 11 and the negative switch 12 perform the ON motion and the OFF motion according to the ON signal and the OFF signal output from the switch control unit 13.

When the brake by the mechanical brake device 2 is actuated (for example, since the start to the time t₁₁), the switch control unit 13 outputs the OFF signal to the positive switch 11 and the negative switch 12. The positive switch 11 and the negative switch 12 that have received the OFF signal from the switch control unit 13 perform the OFF motion and open the positive electric circuit 43P and the negative electric circuit 43N between the power supply 10 and the brake coil 25. In this way, the current from the power supply 10 to the brake coil 25 is cut off, and thus the voltage and the current of the brake coil 25 are 0 (zero). Since an electromagnetic force is not generated in the brake coil 25, the armature 22 is strongly pressed against the friction plate 21 by an elastic force of the spring 24, and the brake by the mechanical brake device 2 is actuated.

The brake releasing processing starts at the time t₁₁. The switch control unit 13 outputs the ON signal to the positive switch 11 and the negative switch 12 at the time t₁₁. The positive switch 11 and the negative switch 12 that have received the ON signal from the switch control unit 13 close the positive electric circuit 43P and the negative electric circuit 43N. In this way, the voltage of the brake coil 25 is V1, the current (maximum value is I₁) flows from the power supply 10 to the brake coil 25, and an electromagnetic force that defeats an elastic force of the spring 24 for pressing the armature 22 against the friction plate 21 is generated in the core 26. The armature 22 is brought closer to the core 26 by the electromagnetic force, and the friction plate 21 is released from contact with the armature 22 and the end plate 23. As a result, the friction plate 21 and thus the shaft 31 of the motor can freely rotate, which results in a state where the brake for the motor is released.

At and after a time t₁₂, in order to maintain the brake releasing state, the switch control unit 13 alternately switches between and performs, for each predetermined period of time T, an output of the ON signal and the OFF signal subjected to PWM control for the positive switch 11 and an output of the ON signal and the OFF signal subjected to PWM control for the negative switch 12. As the predetermined period of time T for performing PWM control, for example, about 500 milliseconds is set, but a numerical value herein is merely one example, and the other numerical value may be set. The predetermined period of time T may be stored in a rewritable storage unit (not illustrated) and be rewritable by an external apparatus, and can thus be changed to an appropriate value as necessary even after the predetermined period of time T is set once.

For example, for a switch having a higher fault probability of the positive switch 11 and the negative switch 12, when a longer period of time is set as the predetermined period of time T for performing PWM control, a fault of the switch having the higher fault probability can be predominantly monitored. Further, for example, for a switch being more excellent in heat dissipation of the positive switch 11 and the negative switch 12, when a longer period of time is set as the predetermined period of time T for performing PWM control, heat generation by a switching motion of the switch being more excellent in the heat dissipation can be suppressed.

In order to maintain the brake releasing state, the switch control unit 13 outputs the ON signal and the OFF signal subjected to PWM control for the positive switch 11 and outputs the ON signal to the negative switch 12 between the time t₁₂ and a time t₁₃, between a time t₁₄ and a time t₁₅, and between a time t₁₆ and a time t₁₇. The positive switch 11 that has received the ON signal and the OFF signal subjected to PWM control by the switch control unit 13 performs the ON motion and the OFF motion, and closes and opens the positive electric circuit 43P between the power supply 10 and the brake coil 25. The negative switch 12 that has received the ON signal from the switch control unit 13 closes the negative electric circuit 43N. In this way, the voltage of the brake coil 25 fluctuates between V₁ and 0 (zero) in a vibrating manner. Further, a vibrational current smaller than the maximum value I₁ of the brake coil current flows from the power supply 10 to the brake coil 25. A duty ratio used in PWM control is set to magnitude to an extent that an electromagnetic force defeating an elastic force of the spring 24 is generated, and thus the brake releasing state where the friction plate 21 is released from contact with the armature 22 and the end plate 23 can be maintained.

In order to maintain the brake releasing state, the switch control unit 13 outputs the ON signal to the positive switch 11 and outputs the ON signal and the OFF signal subjected to PWM control for the negative switch 12 between the time t₁₃ and the time t₁₄, between the time t₁₅ and the time t₁₆, and at and after the time t₁₇. The positive switch 11 that has received the ON signal from the switch control unit 13 closes the positive electric circuit 43P. The negative switch 12 that has received the ON signal and the OFF signal subjected to PWM control by the switch control unit 13 performs the ON motion and the OFF motion, and closes and opens the negative electric circuit 43N between the power supply 10 and the brake coil 25. In this way, the voltage of the brake coil 25 fluctuates between V₁ and 0 (zero) in a vibrating manner. Further, a vibrational current smaller than the maximum value I₁ of the brake coil current flows from the power supply 10 to the brake coil 25. A duty ratio used in PWM control is set to magnitude to an extent that an electromagnetic force defeating an elastic force of the spring 24 is generated, and thus the brake releasing state where the friction plate 21 is released from contact with the armature 22 and the end plate 23 can be maintained.

In such a manner, at and after the time t₁₂ at which the brake releasing state is maintained, the switch control unit 13 alternately switches between and performs, for each predetermined period of time T, an output of the ON signal and the OFF signal subjected to PWM control for the positive switch 11 and an output of the ON signal and the OFF signal subjected to PWM control for the negative switch 12. When the positive switch 11 and the negative switch 12 are normal, the positive switch 11 and the negative switch 12 perform the ON motion and the OFF motion according to the ON signal and the OFF signal subjected to PWM control alternately performed on the positive switch 11 and the negative switch 12, and thus the voltage and the current of the brake coil 25 change in a vibrating manner. The detection unit 14 detects, as electricity information, the voltage applied to the brake coil 25 of the mechanical brake device 2 or the current flowing through the brake coil 25. The diagnostic unit 15 determines that both of the positive switch 11 and the negative switch 12 are normal when the electricity information detected by the detection unit 14 always changes in a vibrating manner at and after the time t 12 at which the switch control unit 13 alternately switches between and performs, for each predetermined period of time, PWM control for performing ON/OFF control on the positive switch 11 and PWM control for performing ON/OFF control on the negative switch 12.

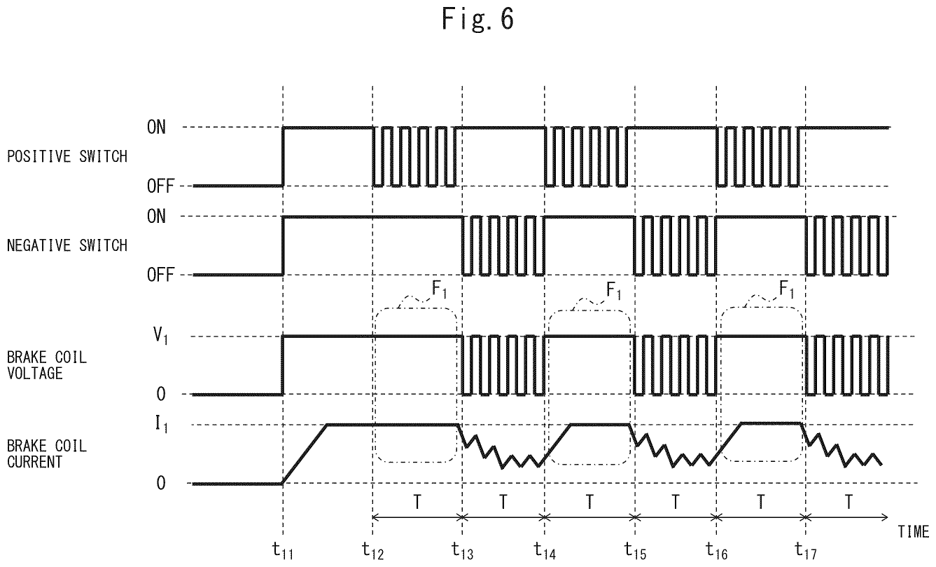

FIG. 6 is a timing chart illustrating each waveform when the positive switch of the brake driving device according to the first and second embodiments of the present disclosure experiences a short circuit failure.

For example, when the positive switch 11 experiences a short circuit failure and the negative switch 12 is normal, the positive switch 11 continues to perform the ON motion regardless of the ON signal and the OFF signal output from the switch control unit 13. Meanwhile, the negative switch 12 being normal performs the ON motion and the OFF motion according to the ON signal and the OFF signal output from the switch control unit 13.

When the brake by the mechanical brake device 2 is actuated (for example, since the start to the time t₁₁), the switch control unit 13 outputs the OFF signal to the positive switch 11 and the negative switch 12. The positive switch 11 experiencing a short circuit failure does not perform the OFF motion even when the positive switch 11 receives the OFF signal from the switch control unit 13, and the positive electric circuit 43P between the power supply 10 and the brake coil 25 continues to be closed. Meanwhile, the negative switch 12 that has received the OFF signal from the switch control unit 13 performs the OFF motion and opens the negative electric circuit 43N between the power supply 10 and the brake coil 25. Since the negative electric circuit 43N between the power supply 10 and the brake coil 25 is open, the current from the power supply 10 to the brake coil 25 is cut off, and therefore the voltage and the current of the brake coil 25 are 0 (zero). Since an electromagnetic force is not generated in the brake coil 25, the armature 22 is strongly pressed against the friction plate 21 by an elastic force of the spring 24, and the brake by the mechanical brake device 2 is actuated.

The brake releasing processing starts at the time t₁₁. The switch control unit 13 outputs the ON signal to the positive switch 11 and the negative switch 12 at the time t₁₁. The positive switch 11 and the negative switch 12 that have received the ON signal from the switch control unit 13 close the positive electric circuit 43P and the negative electric circuit 43N. In this way, the voltage of the brake coil 25 is V1, the current (maximum value is I₁) flows from the power supply 10 to the brake coil 25, and an electromagnetic force that defeats an elastic force of the spring 24 for pressing the armature 22 against the friction plate 21 is generated in the core 26. The armature 22 is brought closer to the core 26 by the electromagnetic force, and the friction plate 21 is released from contact with the armature 22 and the end plate 23. As a result, the friction plate 21 and thus the shaft 31 of the motor can freely rotate, which results in a state where the brake for the motor is released.

At and after the time t₁₂, in order to maintain the brake releasing state, the switch control unit 13 alternately switches between and performs, for each predetermined period of time T, an output of the ON signal and the OFF signal subjected to PWM control for the positive switch 11 and an output of the ON signal and the OFF signal subjected to PWM control for the negative switch 12.

In other words, the switch control unit 13 outputs the ON signal and the OFF signal subjected to PWM control for the positive switch 11 and outputs the ON signal to the negative switch 12 between the time t₁₂ and the time t₁₃, between the time t₁₄ and the time t₁₅, and between the time t₁₆ and the time t₁₇. Since the positive switch 11 that has received the ON signal and the OFF signal subjected to PWM control by the switch control unit 13 experiences a short circuit failure, the positive electric circuit 43P between the power supply 10 and the brake coil 25 continues to be closed. The negative switch 12 that has received the ON signal from the switch control unit 13 closes the negative electric circuit 43N. Thus, during that time, both of the positive switch 11 and the negative switch 12 are in a closed state similarly to the time from the time t₁₁ to the time t₁₂, and a waveform F₁ in which the voltage of the brake coil 25 is V₁ and the current (maximum value is I₁) flows from the power supply 10 to the brake coil 25 appears. As described with reference to FIG. 5, when the positive switch 11 is normal, it is expected that the voltage of the brake coil 25 fluctuates between V₁ and 0 (zero) in a vibrating manner in response to the ON signal and the OFF signal subjected to PWM control, and the vibrational current smaller than the maximum value I₁ of the brake coil current flows from the power supply 10 to the brake coil 25. However, the positive switch 11 experiences a short circuit failure, and thus the waveform F₁ in which the fixed voltage V₁ is applied to the brake coil 25 and the fixed current I₁ flows through the brake coil 25 appears. It should be noted that an electromagnetic force that defeats an elastic force of the spring 24 is generated, and thus the brake releasing state where the friction plate 21 is released from contact with the armature 22 and the end plate 23 can be maintained.

The switch control unit 13 outputs the ON signal to the positive switch 11 and outputs the ON signal and the OFF signal subjected to PWM control for the negative switch 12 between the time t₁₃ and the time t₁₄, between the time t₁₅ and the time t₁₆, and at and after the time 117. The positive switch 11 that has received the ON signal from the switch control unit 13 closes the positive electric circuit 43P. The negative switch 12 that has received the ON signal and the OFF signal subjected to PWM control by the switch control unit 13 performs the ON motion and the OFF motion, and closes and opens the negative electric circuit 43N between the power supply 10 and the brake coil 25. In this way, the voltage of the brake coil 25 fluctuates between V₁ and 0 (zero) in a vibrating manner, and the vibrational current smaller than the maximum value I₁ of the brake coil current flows from the power supply 10 to the brake coil 25. A duty ratio used in PWM control is set to magnitude to an extent that an electromagnetic force defeating an elastic force of the spring 24 is generated, and thus the brake releasing state where the friction plate 21 is released from contact with the armature 22 and the end plate 23 can be maintained.

In such a manner, when the positive switch 11 experiences a short circuit failure, at and after the time t₁₂ at which an output of the ON signal and the OFF signal subjected to PWM control for the positive switch 11 and an output of the ON signal and the OFF signal subjected to PWM control for the negative switch 12 are alternately switched and performed for each predetermined period of time T, the waveform F₁ in which the fixed voltage V₁ is applied to the brake coil 25 and the fixed current I₁ flows through the brake coil 25 appears. Thus, the diagnostic unit 15 determines that the positive switch 11 experiences a short circuit failure when electricity information detected by the detection unit 14 has a substantially fixed value equal to or more than a prescribed first threshold value while the ON signal and the OFF signal subjected to PWM control for the positive switch 11 are output (between the time t₁₂ and the time t₁₃, between the time t₁₄ and the time t₁₅, and between the time t₁₆ and the time t₁₇). Herein, the first threshold value is set to a value (for example, a value lower by about 10% to about 20%) lower to some extent than a maximum voltage value in which the brake coil voltage may take when the electricity information is voltage, and the first threshold value is set to a value (for example, a value lower by about 10% to about 20%) lower to some extent than a maximum current value in which the brake coil current may take when the electricity information is current. The numerical example indicated herein is merely one example, and the other value may be set. It should be noted that the first threshold value may be stored in a rewritable storage unit (not illustrated) and be rewritable by an external apparatus, and can be thus changed to an appropriate value as necessary even after the first threshold value is set once.

The case where the positive switch 11 experiences a short circuit failure is described above as an example in FIG. 6. The description in FIG. 6 in which the positive switch 11 is replaced with the negative switch 12 is applied to description of a short circuit failure in the negative switch 12. In other words, the diagnostic unit 15 determines that the negative switch 12 experiences a short circuit failure when electricity information detected by the detection unit 14 has a substantially fixed value equal to or more than the prescribed first threshold value while PWM control for performing ON/OFF control on the negative switch 12 is performed (between the time t₁₃ and the time t₁₄, between the time t₁₅ and the time t₁₆, and at and after the time t₁₇).

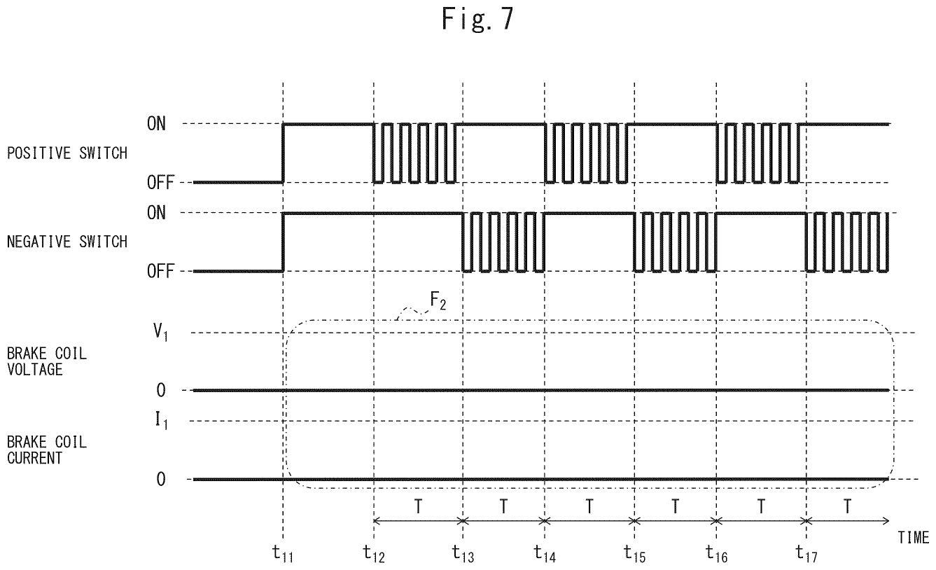

FIG. 7 is a timing chart illustrating each waveform when the positive switch of the brake driving device according to the first and second embodiments of the present disclosure experiences an open circuit failure.

For example, when the positive switch 11 experiences an open circuit failure and the negative switch 12 is normal, the positive switch 11 continues to perform the OFF motion regardless of the ON signal and the OFF signal output from the switch control unit 13. Meanwhile, the negative switch 12 being normal performs the ON motion and the OFF motion according to the ON signal and the OFF signal output from the switch control unit 13.

When the brake by the mechanical brake device 2 is actuated (for example, since the start to the time t₁₁), the switch control unit 13 outputs the OFF signal to the positive switch 11 and the negative switch 12. Since the positive switch 11 experiences an open circuit failure, the positive electric circuit 43P between the power supply 10 and the brake coil 25 continues to be open. Meanwhile, the negative switch 12 that has received the OFF signal from the switch control unit 13 performs the OFF motion and opens the negative electric circuit 43N between the power supply 10 and the brake coil 25. Since the negative electric circuit 43N between the power supply 10 and the brake coil 25 is open, the current from the power supply 10 to the brake coil 25 is cut off, and therefore the voltage and the current of the brake coil 25 are 0 (zero). Since an electromagnetic force is not generated in the brake coil 25, the armature 22 is strongly pressed against the friction plate 21 by an elastic force of the spring 24, and the brake by the mechanical brake device 2 is actuated.

The brake releasing processing starts at the time t₁₁. The switch control unit 13 outputs the ON signal to the positive switch 11 and the negative switch 12 at the time t₁₁. The negative switch 12 that has received the ON signal from the switch control unit 13 closes the negative electric circuit 43N between the power supply 10 and the brake coil 25. However, the positive switch 11 experiences an open circuit failure, and thus the positive switch 11 does not perform the ON motion, and the positive electric circuit 43P between the power supply 10 and the brake coil 25 continues to be open. Thus, the current from the power supply 10 to the brake coil 25 is cut off, and therefore the voltage and the current of the brake coil 25 are 0 (zero). Since an electromagnetic force is not generated in the brake coil 25, the armature 22 is strongly pressed against the friction plate 21 by an elastic force of the spring 24, and the brake by the mechanical brake device 2 continues to be actuated.

At and after the time t₁₂, the switch control unit 13 alternately switches between and performs, for each predetermined period of time T, an output of the ON signal and the OFF signal subjected to PWM control for the positive switch 11 and an output of the ON signal and the OFF signal subjected to PWM control for the negative switch 12.

In other words, the switch control unit 13 outputs the ON signal and the OFF signal subjected to PWM control for the positive switch 11 and outputs the ON signal to the negative switch 12 between the time t₁₂ and the time t₁₃, between the time t₁₄ and the time t₁₅, and between the time t₁₆ and the time t₁₇. Since the positive switch 11 that has received the ON signal and the OFF signal subjected to PWM control by the switch control unit 13 experiences an open circuit failure, the positive switch 11 does not perform the ON motion, and the positive electric circuit 43P between the power supply 10 and the brake coil 25 continues to be open. Further, the negative switch 12 that has received the ON signal from the switch control unit 13 closes the negative electric circuit 43N between the power supply 10 and the brake coil 25. Thus, during that time, the positive switch 11 and the negative switch 12 are in an open state, and a waveform F₂ in which both of the voltage and the current of the brake coil 25 are 0 appears.

The switch control unit 13 outputs the ON signal to the positive switch 11 and outputs the ON signal and the OFF signal subjected to PWM control for the negative switch 12 between the time t₁₃ and the time t₁₄, between the time t₁₅ and the time t₁₆, and at and after the time t₁₇. The negative switch 12 that has received the ON signal and the OFF signal subjected to PWM control by the switch control unit 13 performs the ON motion and the OFF motion, and closes and opens the negative electric circuit 43N between the power supply 10 and the brake coil 25. However, the positive switch 11 experiences an open circuit failure, and thus the positive electric circuit 43P between the power supply 10 and the brake coil 25 continues to be open. Thus, during that time, the positive switch 11 and the negative switch 12 are in an open state, and a waveform F₂ in which both of the voltage and the current of the brake coil 25 are 0 appears.

As described with reference to FIG. 5, when the positive switch 11 is normal, it is expected that the voltage of the brake coil 25 fluctuates between V₁ and 0 (zero) in a vibrating manner in response to the ON signal and the OFF signal subjected to PWM control, and the vibrational current smaller than the maximum value I₁ of the brake coil current flows from the power supply 10 to the brake coil 25. However, the positive switch 11 experiences an open circuit failure, and thus the waveform F₂ in which both of the voltage and the current of the brake coil 25 are 0 always appears. Thus, the diagnostic unit 15 determines that at least one of the positive switch 11 and the negative switch 12 experiences an open circuit failure when electricity information detected by the detection unit 14 has a substantially fixed value equal to or less than a prescribed second threshold value while the switch control unit 13 outputs the ON signal and the OFF signal subjected to PWM control for the positive switch 11 (between the time t₁₂ and the time t₁₃, between the time t₁₄ and the time t₁₅, and between the time t₁₆ and the time t₁₇) and while the switch control unit 13 outputs the ON signal and the OFF signal subjected to PWM control for the negative switch 12 (between the time t₁₃ and the time t₁₄, between the time t₁₅ and the time t₁₆, and at and after the time t₁₇). Herein, the second threshold value is set to a positive value near 0 bolt when the electricity information is voltage, and the second threshold value is set to a positive value near 0 ampere when the electricity information is current. The numerical example indicated herein is merely one example, and the other value may be set. It should be noted that the second threshold value may be stored in a rewritable storage unit (not illustrated) and be rewritable by an external apparatus, and can be thus changed to an appropriate value as necessary even after the second threshold value is set once.

The case where the positive switch 11 experiences an open circuit failure is described above as the example in FIG. 7. The description in FIG. 7 in which the positive switch 11 is replaced with the negative switch 12 is applied to an open circuit failure in the negative switch 12.

When the negative switch 12 experiences an open circuit failure, the waveform F₂ in which both of the voltage and the current of the brake coil 25 are 0 also always appears as illustrated in FIG. 7. In other words, when the positive switch 11 experiences an open circuit failure and when the negative switch 12 experiences an open circuit failure, the waveform F₂ in which both of the voltage and the current of the brake coil 25 are 0 appears. Thus, whether the positive switch 11 experiences an open circuit failure, the negative switch 12 experiences an open circuit failure, or both of the positive switch 11 and the negative switch 12 are faulty due to an open circuit cannot be distinguished from the waveform F₂ in which both of the voltage and the current of the brake coil 25 are 0. The diagnostic unit 15 determines that at least one of the positive switch 11 and the negative switch 12 experiences an open circuit failure when electricity information detected by the detection unit 14 has a substantially fixed value equal to or less than the second threshold value.

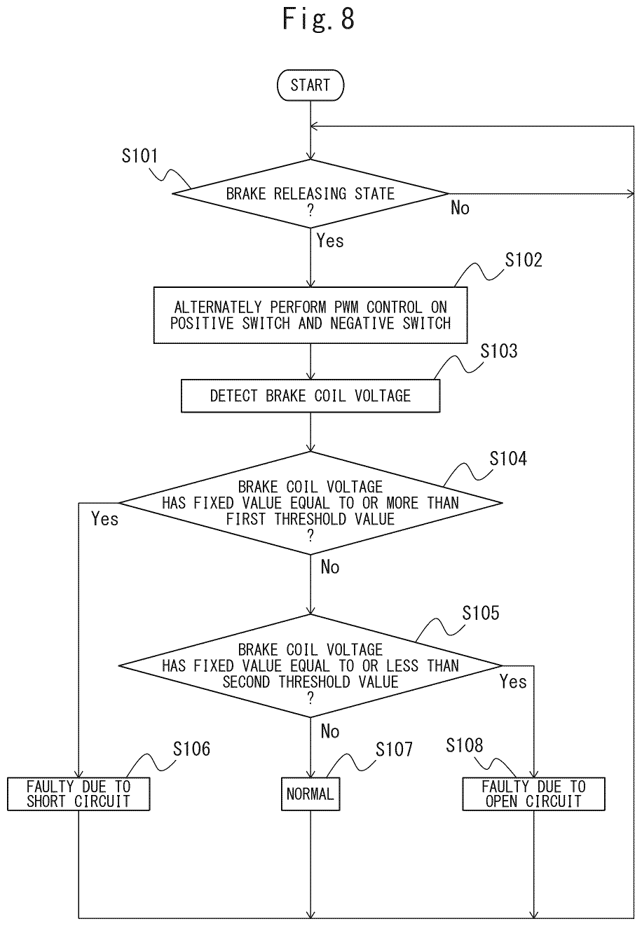

FIG. 8 is a flowchart illustrating a motion related to a fault diagnosis in the brake driving device according to the first embodiment of the present disclosure. Herein, as one example, electricity information detected by the detection unit 14 is assumed to be a voltage applied to the brake coil 25. When electricity information detected by the detection unit 14 is assumed to be a current flowing through the brake coil 25, the flowchart illustrated in FIG. 8 is applied by replacing “voltage applied to the brake coil 25” with “current flowing through the brake coil 25”.

In step S101, the switch control unit 13 and the diagnostic unit 15 determine whether the mechanical brake device 2 is in the brake releasing state. When the mechanical brake device 2 is determined to be in the brake actuating state, the processing returns to step S101. At a point in time at which the mechanical brake device 2 is determined to be in the brake releasing state, the switch control unit 13 first outputs the ON signal to the positive switch 11 and the negative switch 12 at a time of brake release start, and then the processing proceeds to step $102.

In step S102, the switch control unit 13 alternately switches between and performs, for each predetermined period of time, an output of the ON signal and the OFF signal subjected to PWM control for the positive switch 11 and an output of the ON signal and the OFF signal subjected to PWM control for the negative switch 12. The switch control unit 13 outputs the ON signal to the negative switch 12 while the switch control unit 13 outputs the ON signal and the OFF signal subjected to PWM control for the positive switch 11. Further, the switch control unit 13 outputs the ON signal to the positive switch 11 while the switch control unit 13 outputs the ON signal and the OFF signal subjected to PWM control for the negative switch 12.

In step S103, the detection unit 14 detects a brake coil voltage. Information about the detected brake coil voltage is transmitted to the diagnostic unit 15.

In step S104, the diagnostic unit 15 determines whether the brake coil voltage has a substantially fixed value equal to or more than a first threshold value.

When it is determined in step S104 that the voltage applied to the brake coil 25 has a substantially fixed value equal to or more than the first threshold value, the processing proceeds to step S106. In step S106, the diagnostic unit 15 determines that the positive switch 11 experiences a short circuit failure when, in step S104, the diagnostic unit 15 determines that the brake coil voltage detected by the detection unit 14 has a substantially fixed value equal to or more than the first threshold value while the ON signal and the OFF signal subjected to PWM control for the positive switch 11 are output. Further, in step S106, the diagnostic unit 15 determines that the negative switch 12 experiences a short circuit failure when, in step S104, the diagnostic unit 15 determines that the brake coil voltage detected by the detection unit 14 has a substantially fixed value equal to or more than the first threshold value while the ON signal and the OFF signal subjected to PWM control for the negative switch 12 are output. After step S106, the processing returns to step S101.

When it is not determined in step S104 that the voltage applied to the brake coil 25 has a substantially fixed value equal to or more than the first threshold value, the processing proceeds to step S105. In step S105, the diagnostic unit 15 determines whether the brake coil voltage has a substantially fixed value equal to or less than a second threshold value.

When it is determined in step S105 that the brake coil voltage has a substantially fixed value equal to or less than the second threshold value, the processing proceeds to step S108. In step S108, the diagnostic unit 15 determines that at least one of the positive switch 11 and the negative switch 12 experiences an open circuit failure. After step S108, the processing returns to step S101.

When it is not determined in step S105 that the brake coil voltage has a substantially fixed value equal to or less than the second threshold value, the processing proceeds to step S107. In step S107, the diagnostic unit 15 determines that both of the positive switch 11 and the negative switch 12 are normal. After step S107, the processing returns to step S101.

It should be noted that, the processing in step S104 and the processing in step S105 may be executed in a switched order.

According to the first embodiment of the present disclosure, a diagnosis of a fault in the positive switch 11 and the negative switch 12 can be easily made by the diagnostic unit 15 while PWM control for the positive switch 11 and PWM control for the negative switch are performed in the brake releasing state. Furthermore, by performing PWM control for the positive switch 11 and PWM control for the negative switch in the brake releasing state, the brake releasing state is maintained with less power than that at a time of brake release start, and thus the mechanical brake device 2 can be reduced in size and heat generation.

### Configuration of Brake Driving Device According to Second Embodiment

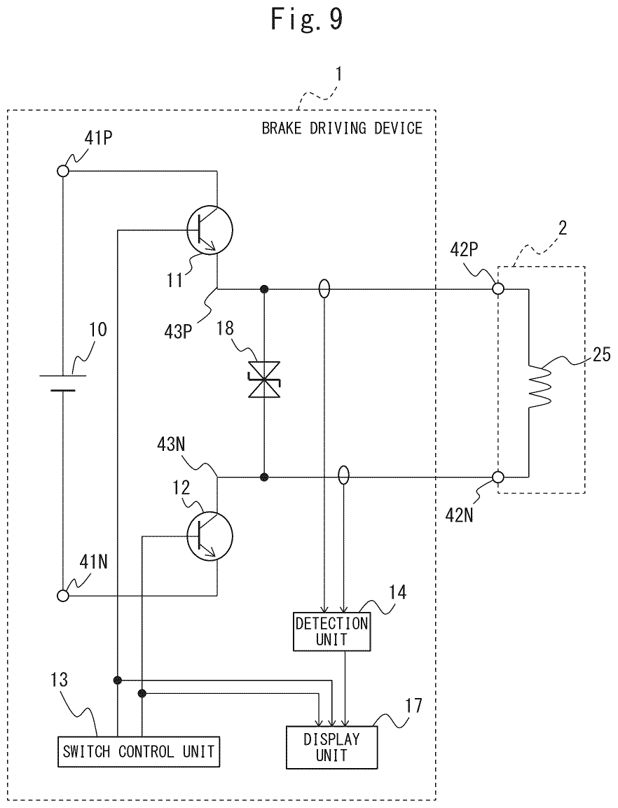

FIG. 9 is a circuit diagram illustrating the brake driving device according to the second embodiment of the present disclosure.

In the first embodiment described with reference to FIGS. 1 to 8, diagnostic processing is executed by the diagnostic unit 15, based on electricity information detected by the detection unit 14. In the second embodiment, a display unit 17 configured to display electricity information detected by the detection unit 14 is provided instead of the diagnostic unit 15 and the alarm output unit 16 in FIG. 1.

As illustrated in FIG. 9, a brake driving device 1 according to the second embodiment of the present disclosure includes a power supply 10, a positive switch 11, a negative switch 12, a switch control unit 13, a detection unit 14, the display unit 17, and a surge absorber 18. FIG. 9 illustrates only a brake coil 25 for a mechanical brake device 2 controlled by the brake driving device 1.

The mechanical brake device 2, the power supply 10, the positive switch 11, the negative switch 12, the switch control unit 13, the detection unit 14, and the surge absorber 18 are as described with reference to FIGS. 1 to 9 in the first embodiment.

The display unit 17 displays electricity information detected by the detection unit 14 while the switch control unit 13 alternately switches between and performs, for each predetermined period of time, an output of the ON signal and the OFF signal subjected to PWM control for the positive switch 11 and an output of the ON signal and the OFF signal subjected to PWM control for the negative switch 12. As an example of the display unit 17, there are a single display device, a display device attached to the brake driving device 1 or a motor driving device including the brake driving device 1, a display device attached to a personal computer and a portable terminal, and the like.

### Motion of Brake Driving Device According to Second Embodiment

The description related to the timing charts illustrated in FIGS. 5 to 7 is also applicable to the second embodiment.

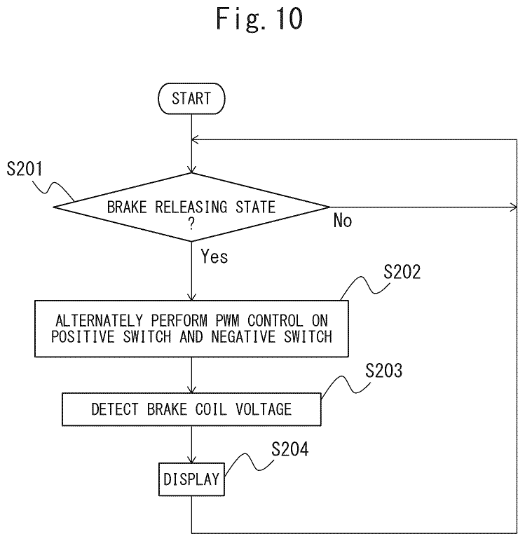

FIG. 10 is a flowchart illustrating a motion related to a fault diagnosis in the brake driving device according to the second embodiment of the present disclosure. Herein, as one example, electricity information detected by the detection unit 14 is assumed to be a voltage applied to the brake coil 25. When electricity information detected by the detection unit 14 is assumed to be a current flowing through the brake coil 25, the flowchart illustrated in FIG. 10 is applied by replacing “voltage applied to the brake coil 25” with “current flowing through the brake coil 25”.

In step S201, the switch control unit 13 determines whether the mechanical brake device 2 is in the brake releasing state. When the mechanical brake device 2 is determined to be in the brake actuating state, the processing returns to step S201. At a point in time at which the mechanical brake device 2 is determined to be in the brake releasing state, the switch control unit 13 first outputs the ON signal to the positive switch 11 and the negative switch 12 at a time of brake release start, and then the processing proceeds to step S102.

In step S202, the switch control unit 13 alternately switches between and performs, for each predetermined period of time, an output of the ON signal and the OFF signal subjected to PWM control for the positive switch 11 and an output of the ON signal and the OFF signal subjected to PWM control for the negative switch 12. The switch control unit 13 outputs the ON signal to the negative switch 12 while the switch control unit 13 outputs the ON signal and the OFF signal subjected to PWM control for the positive switch 11. Further, the switch control unit 13 outputs the ON signal to the positive switch 11 while the switch control unit 13 outputs the ON signal and the OFF signal subjected to PWM control for the negative switch 12.

In step S203, the detection unit 14 detects a brake coil voltage. Information about the detected brake coil voltage is transmitted to the display unit 17.

In step S203, the display unit 17 displays the brake coil voltage.

For example, as illustrated in FIGS. 4 to 6, the display unit 17 displays the brake coil voltage detected by the detection unit 14 while the switch control unit 13 alternately switches between and performs, for each predetermined period of time, an output of the ON signal and the OFF signal subjected to PWM control for the positive switch 11 and an output of the ON signal and the OFF signal subjected to PWM control for the negative switch 12. By confirming a display content of the display unit 17, an operator can determine whether the positive switch 11 and the negative switch 12 are normal, the positive switch 11 experiences a short circuit failure, the negative switch experiences a short circuit failure, or at least one of the positive switch 11 and the negative switch experiences an open circuit failure.

According to the second embodiment of the present disclosure, an operator can easily make a diagnosis of a fault in the positive switch 11 and the negative switch 12, based on a display content of electricity information about the brake coil 25 of the mechanical brake device 2 by the display unit 17, while PWM control for the positive switch 11 and PWM control for the negative switch are performed in the brake releasing state. Furthermore, by performing PWM control for the positive switch 11 and PWM control for the negative switch in the brake releasing state, the brake releasing state is maintained with less power than that at a time of brake release start, and thus the mechanical brake device 2 can be reduced in size and heat generation.

### Achievement in Both of Fault Diagnosis and Reduction in Size and Heat Generation of Mechanical Brake Device

According to the first and second embodiments of the present disclosure, by performing PWM control for the positive switch 11 and PWM control for the negative switch in the brake releasing state, a diagnosis of a fault in the positive switch 11 and the negative switch 12 can be easily made, and the mechanical brake device 2 can also be reduced in size and heat generation.

Although the present disclosure has been described above in detail, the present disclosure is not limited to the individual embodiments described above. Various types of addition, replacement, modification, partial deletion, and the like may be made to the embodiments without departing from the purpose of the present disclosure or without departing from the contents described in the claims and the scope of the present disclosure derived from equivalents thereof. Further, the embodiments can be performed in combination. For example, in the embodiments described above, an order of operations and an order of pieces of processing are indicated as one example, which is not limited thereto. Further, the same also applies to a case where a numerical value or a numerical expression is used in the description of the embodiments described above.

### Supplementary Note

With regard to the embodiments and the modification examples described above, supplementary notes below are further disclosed.

### (Supplementary Note 1)

A brake driving device 1 including:
a positive switch 11 configured to close a positive electric circuit 43P between a positive terminal 41P of a power supply 10 and a positive terminal 42P of a mechanical brake device 2 of a non-excitation actuating type by performing an ON motion, and open the positive electric circuit 43P by performing an OFF motion;
a negative switch 12 configured to close a negative electric circuit 43N between a negative terminal 41N of the power supply 10 and a negative terminal 42N of the mechanical brake device 2 by performing the ON motion, and open the negative electric circuit 43N by performing the OFF motion; and
a switch control unit 13 configured to output, to the positive switch 11 and the negative switch 12, an ON signal for causing the ON motion to be performed and an OFF signal for causing the OFF motion to be performed, wherein
the switch control unit 13
outputs, when a brake by the mechanical brake device 2 is actuated, the OFF signal to the positive switch 11 and the negative switch 12, and
outputs, when the brake by the mechanical brake device 2 is released, the ON signal to the positive switch 11 and the negative switch 12 at a time of brake release start, and then alternately switches between and performs, for each predetermined period of time, an output of the ON signal and the OFF signal subjected to PWM control for the positive switch 11 and an output of the ON signal and the OFF signal subjected to PWM control for the negative switch 12 while release of the brake by the mechanical brake device 2 is maintained.

### (Supplementary Note 2)

The brake driving device 1 according to supplementary note 1, wherein
the switch control unit 13 outputs the ON signal to the negative switch 12 while the switch control unit 13 outputs the ON signal and the OFF signal subjected to PWM control for the positive switch 11, and the switch control unit 13 outputs the ON signal to the positive switch 11 while the switch control unit 13 outputs the ON signal and the OFF signal subjected to PWM control for the negative switch 12.

### (Supplementary Note 3)

The brake driving device 1 according to supplementary note 2, further including:
a detection unit 14 configured to detect electricity information being at least one of a voltage applied to a brake coil 25 of the mechanical brake device 2 and a current flowing through the brake coil 25; and
a diagnostic unit 15 configured to make a diagnosis of presence or absence of a fault in the positive switch 11 and the negative switch 12, based on the electricity information detected by the detection unit 14, while the switch control unit 13 alternately switches between and performs, for each predetermined period of time, an output of the ON signal and the OFF signal subjected to PWM control for the positive switch 11 and an output of the ON signal and the OFF signal subjected to PWM control for the negative switch 12.

### (Supplementary Note 4)

The brake driving device 1 according to supplementary note 3, wherein
the diagnostic unit 15
determines that the positive switch 11 experiences a short circuit failure when the electricity information detected by the detection unit 14 has a substantially fixed value equal to or more than a prescribed first threshold value while the switch control unit 13 outputs the ON signal and the OFF signal subjected to PWM control for the positive switch 11, and
determines that the negative switch 12 experiences a short circuit failure when the electricity information detected by the detection unit 14 has a substantially fixed value equal to or more than the first threshold value while the switch control unit 13 outputs the ON signal and the OFF signal subjected to PWM control for the negative switch 12.

### (Supplementary Note 5)

The brake driving device 1 according to supplementary note 3, wherein
the diagnostic unit 15 determines that at least one of the positive switch 11 and the negative switch 12 experiences an open circuit failure when the electricity information detected by the detection unit 14 has a substantially fixed value equal to or less than a prescribed second threshold value while the switch control unit 13 outputs the ON signal and the OFF signal subjected to PWM control for the positive switch 11 and while the switch control unit 13 outputs the ON signal and the OFF signal subjected to PWM control for the negative switch 12.

### (Supplementary Note 6)

The brake driving device 1 according to supplementary note 3, further including
an alarm output unit configured to output an alarm when the diagnostic unit 15 determines that at least one of the positive switch 11 and the negative switch 12 is faulty.

### (Supplementary Note 7)

The brake driving device 1 according to supplementary note 2, further including:
a detection unit 14 configured to detect electricity information being at least one of a voltage applied to a brake coil 25 of the mechanical brake device 2 and a current flowing through the brake coil 25; and
a display unit 17 configured to display the electricity information detected by the detection unit 14 while the switch control unit 13 alternately switches between and performs, for each predetermined period of time, an output of the ON signal and the OFF signal subjected to PWM control for the positive switch 11 and an output of the ON signal and the OFF signal subjected to PWM control for the negative switch 12.

### (Supplementary Note 8)

The brake driving device 1 according to any one of supplementary notes 1 to 7, wherein
the mechanical brake device 2 applies a brake to a motor by pressing, by an elastic force of a spring 24, an armature 22 against a friction plate 21 to which a shaft 31 of the motor is coupled, and releases the brake to the motor by separating the armature 22 from the friction plate 21 by an electromagnetic force generated by a current flowing through the brake coil 25.

### REFERENCE SIGNS LIST

1 Brake driving device
2 Mechanical brake device
10 Power supply
11 Positive switch
12 Negative switch
13 Switch control unit
14 Detection unit
15 Diagnostic unit
16 Alarm output unit
17 Display unit
18 Surge absorber
21 Friction plate
22 Armature
23 End plate
24 Spring
25 Brake coil
26 Core
27 Spacer
28 Bolt
31 Shaft
32 Hub
41P Positive terminal of power supply
41N Negative terminal of power supply
42P Positive terminal of mechanical brake device
42N Negative terminal of mechanical brake device
43P Positive electric circuit
43N Negative electric circuit

1. A brake driving device comprising:
a positive switch configured to close a positive electric circuit between a positive terminal of a power supply and a positive terminal of a mechanical brake device of a non-excitation actuating type by performing an ON motion, and open the positive electric circuit by performing an OFF motion;
a negative switch configured to close a negative electric circuit between a negative terminal of the power supply and a negative terminal of the mechanical brake device by performing the ON motion, and open the negative electric circuit by performing the OFF motion; and
a switch control unit configured to output, to the positive switch and the negative switch, an ON signal for causing the ON motion to be performed and an OFF signal for causing the OFF motion to be performed, wherein
the switch control unit
outputs, when a brake by the mechanical brake device is actuated, the OFF signal to the positive switch and the negative switch, and
outputs, when the brake by the mechanical brake device is released, the ON signal to the positive switch and the negative switch at a time of brake release start, and then alternately switches between and performs, for each predetermined period of time, an output of the ON signal and the OFF signal subjected to PWM control for the positive switch and an output of the ON signal and the OFF signal subjected to PWM control for the negative switch while release of the brake by the mechanical brake device is maintained.

2. The brake driving device according to claim 1, wherein
the switch control unit outputs the ON signal to the negative switch while the switch control unit outputs the ON signal and the OFF signal subjected to PWM control for the positive switch, and the switch control unit outputs the ON signal to the positive switch while the switch control unit outputs the ON signal and the OFF signal subjected to PWM control for the negative switch.

3. The brake driving device according to claim 2, further comprising:
a detection unit configured to detect electricity information being at least one of a voltage applied to a brake coil of the mechanical brake device and a current flowing through the brake coil; and
a diagnostic unit configured to make a diagnosis of presence or absence of a fault in the positive switch and the negative switch, based on the electricity information detected by the detection unit, while the switch control unit alternately switches between and performs, for each predetermined period of time, an output of the ON signal and the OFF signal subjected to PWM control for the positive switch and an output of the ON signal and the OFF signal subjected to PWM control for the negative switch.

4. The brake driving device according to claim 3, wherein
the diagnostic unit
determines that the positive switch experiences a short circuit failure when the electricity information detected by the detection unit has a substantially fixed value equal to or more than a prescribed first threshold value while the switch control unit outputs the ON signal and the OFF signal subjected to PWM control for the positive switch, and
determines that the negative switch experiences a short circuit failure when the electricity information detected by the detection unit has a substantially fixed value equal to or more than the first threshold value while the switch control unit outputs the ON signal and the OFF signal subjected to PWM control for the negative switch.

5. The brake driving device according to claim 3, wherein
the diagnostic unit determines that at least one of the positive switch and the negative switch experiences an open circuit failure when the electricity information detected by the detection unit has a substantially fixed value equal to or less than a prescribed second threshold value while the switch control unit outputs the ON signal and the OFF signal subjected to PWM control for the positive switch and while the switch control unit outputs the ON signal and the OFF signal subjected to PWM control for the negative switch.

6. The brake driving device according to claim 3, further comprising
an alarm output unit configured to output an alarm when the diagnostic unit determines that at least one of the positive switch and the negative switch is faulty.

7. The brake driving device according to claim 2, further comprising:
a detection unit configured to detect electricity information being at least one of a voltage applied to a brake coil of the mechanical brake device and a current flowing through the brake coil; and
a display unit configured to display the electricity information detected by the detection unit while the switch control unit alternately switches between and performs, for each predetermined period of time, an output of the ON signal and the OFF signal subjected to PWM control for the positive switch and an output of the ON signal and the OFF signal subjected to PWM control for the negative switch.

8. The brake driving device according to claim 1, wherein
the mechanical brake device applies a brake to a motor by pressing, by an elastic force of a spring, an armature against a friction plate to which a shaft of the motor is coupled, and releases the brake to the motor by separating the armature from the friction plate by an electromagnetic force generated by a current flowing through the brake coil.
